(19) United States
(12) Patent Application Publication
(10) Pub. No.: US 2005/0158444 A1
(43) Pub. Date: Jul. 21, 2005

(54) Licorice-containing citrus juice beverage with additional flavoring

(76) Inventor: Dale H. Koski, San Francisco, CA (US)

Correspondence Address: WEST & ASSOCIATES;A PROFESSIONAL CORPORATION, 2121 NORTH CALIFORNIA BOULEVARD, SUITE 290, WALNUT CREEK, CA, 94596, US

(21) Appl. No.: 11/037,496

(22) Filed: Jan. 18, 2005

Related U.S. Application Data
(60) Provisional application No. 60/537,517, filed on Jan. 20, 2004.

(51) Int. Cl. A23F 5/00

(52) U.S. Cl. 426/594

(57) ABSTRACT

A method for production of a licorice-containing juice beverage with additional flavorings and a beverage and associated products produced by such process. The resulting product has an unexpectedly refreshing taste and the beverage can be reduced, thinned or combined with various other foods and beverages to produce various products.

### CLAIM OF PRIORITY

Pursuant to 35 U.S.C. 119(e), this application claims the benefit of the earlier filing date of U.S. Provisional Application No. 60/537,517, filed Jan. 20, 2004.

### FIELD OF ART

The present invention relates to a method for the production of a licorice-containing juice beverage with additional flavoring and to the beverage and associated products produced by such process. More particularly, this invention relates to a licorice-containing beverage comprising various juices together with peppermint, vanilla, spearmint and/or alternate flavoring.

### BACKGROUND

Licorice is a naturally-occurring material that has found wide commercial usage. Licorice contains approximately between 6 and 14 percent glucyrrhizin, which is the goucoside of glycyrrhizic acid, asparagin, sugars and resin. The licorice root contains glycyrrhiza as the mixed calcium and potassium salts of glycyrrhizic acid. The term “glycyrrhizin” is taken from the Greek word “glycyrrhiza” based upon the term “glykys” meaning sweet and “rhyza” meaning root. Glycyrrhizin has a sweetness many times that of sucrose and the black extract made for the dried root of the licorice plant has found usage, for example, as a flavoring agent in medicine and many other products. However, the characteristic flavor of licorice has apparently prevented its usage in various beverages because it is generally incompatible, tastewise, with other flavors.

### BRIEF DESCRIPTION OF THE DRAWINGS

The present invention is described with respect to particular exemplary embodiments thereof and reference is accordingly made to the drawings in which:

FIG. 1 is a flow diagram of a sequence of steps for making a beverage.

### DETAILED DESCRIPTION

These and other objects are achieved in accordance with the present invention wherein a method for the production of a licorice-containing citrus fruit beverage with additional flavorings, and derivatives thereof, is provided.

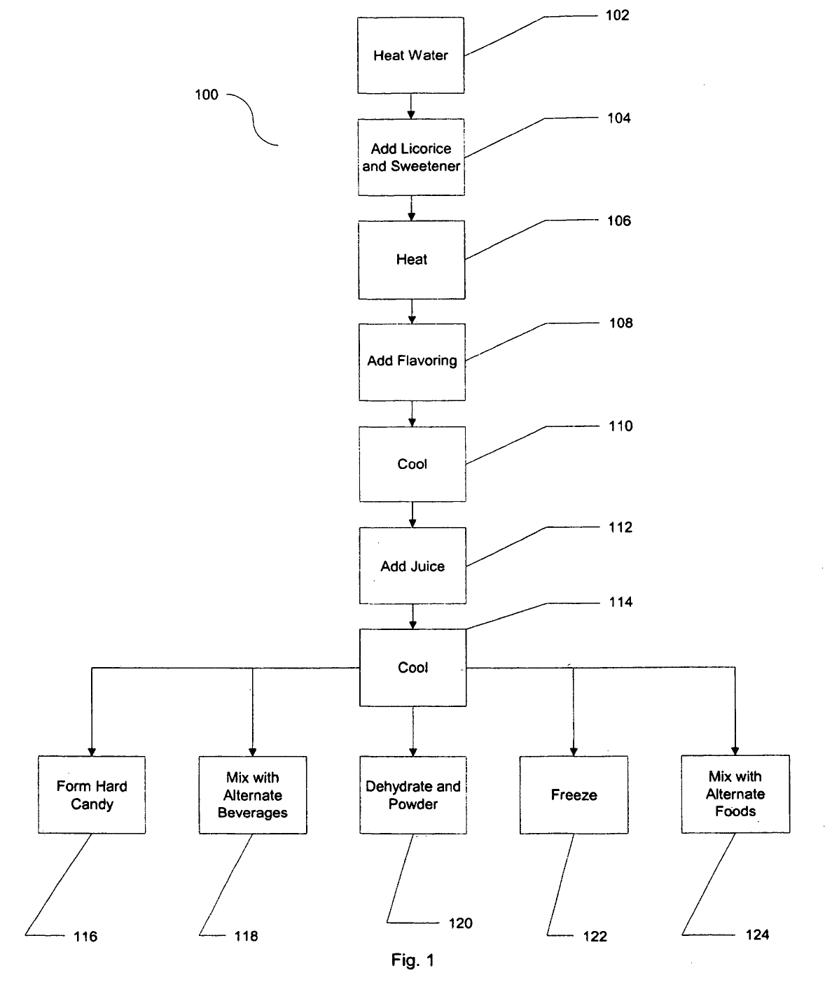

FIG. 1 is a flow diagram 100 of one embodiment of a process for the production of a licorice-containing citrus fruit beverage with additional flavorings. Step 102 is the step of heating water. In the embodiment shown in FIG. 1, the heating method is the application of heat to a container in which the water is contained. However in alternate embodiments, the step of heating the water may be accomplished in any known and/or convenient manner. In one embodiment, the water can be brought to a boil. However in alternate embodiments, the water may be heated to any convenient temperature in a pressurized or unpressurized environment. In a pressurized environment, the water may be heated above its boiling point or made to boil at a lower boiling point than the boiling point at standard pressure.

Step 104 is the step of adding licorice and sweetener to the water from step 102. In the embodiment shown in FIG. 1, the licorice is added to the water in root form. However in alternate embodiments, the licorice may be added in any convenient or known form, such as anise seeds, oil, extract and/or any other convenient form of root and/or seed. In the embodiment shown in FIG. 1, the sweetener added to the water is sugar. However in alternate embodiments, the sweetener may be any known and/or convenient sweetener, such as, honey, sugar cane, any sucrose, fructose, sucralose, aspartame, saccharine, stevia and/or any other known or convenient sweetener.

This step of the present method comprises the formation of an admixture of licorice and tap or preferably, distilled water. The licorice root is preferably reduced to a pelleted form by any suitable means prior to its admixture with water. Suitably, 20 to 30 parts by weight of licorice are admixed with 50 to 70 parts by weight water and the admixture is heated to its boiling point. Additionally, sweetener in an amount of between about 8 and 35 parts by weight is added to the licorice-water admixture at essentially the first signs of ebullition.

Step 106 is the step of adding additional heat to the mixture of step 104. As described above, with regards to step 102, the mixture can be heated in any convenient or known manner. In the embodiment shown in FIG. 1, heat is added to the mixture for between 1 and 3 minutes after the mixture reaches its boiling point. However in alternate embodiments, the heat can be added for any convenient amount of time, based on the desired level of flavor infusion and the desired flavor.

The admixture comprising licorice, water and sugar is boiled in a substantially closed system for a period of time sufficient to result in a palatable beverage when the licorice-containing admixture is finally mixed with juice. The boiling time period may vary depending upon the exact amounts of the various materials that are employed. A suitable time period includes between about one and about three minutes. Following the boiling period, the heating of the mixture is discontinued and the admixture is allowed to steep with the system still substantially closed for a short period of time of between about one and about three minutes. In one embodiment, the boiling time and the steeping time are approximately equal in length.

Step 108 is the step of adding additional flavorings to the mixture described in step 106. In the embodiment described in FIG. 1, the additional flavoring is vanilla added in the form of vanilla extract. In alternate embodiments, the additional flavoring can be peppermint, spearmint or any combination of vanilla, peppermint and/or spearmint. Additionally, in an alternate embodiment, the additional flavoring can be added in any convenient form, such as oil, extract, leaf, base plant and/or any other known or convenient form and in any convenient amount.

Step 110 is the step of cooling the mixture described in step 108. In the embodiment shown in FIG. 1, the mixture is cooled for 1 to 3 minutes. However, in alternate embodiments, the mixture can be cooled for any convenient amount of time or cooled to any convenient temperature.

Step 112 is the step of adding juice. In the embodiment shown in FIG. 1, the added juice is a mixture of orange and lemon juices. In one embodiment, the juice admixture comprises between about 90 and about 150 parts by weight orange juice and between about 30 and about 50 parts by weight lemon juice. In an alternate embodiment, the citrus juice admixture comprises about 120 parts by weight of orange juice and about 40 parts by weight of lemon juice. Either fresh or concentrated juices may be suitably employed.

In alternate embodiments, the juice can be any convenient mixture of fruit juices, such as lemon, orange, lime, mandarin, tangerine, pear, grapefruit, cherry, pineapple, strawberry, cranberry, mango, pomegranate, apple, blackberry, blueberry, lingonberry, loganberry or any other known or convenient fruit or berry. The juice can be mixed with the mixture of step 110 in any convenient form, such as in concentrate form, in freshly-squeezed form, in powdered from, and/or any other convenient or known form.

The licorice-containing admixture and the citrus juices are combined in any suitable manner. For example, an agitated vessel such as a stirred tank may be employed under ambient temperature and pressure conditions.

Step 114 is the step of further cooling the mixture from step 112. In the embodiment shown in FIG. 1, the mixture is allowed to cool naturally at standard temperature and pressure. However in alternate embodiments, the cooling can be accomplished in any convenient or known manner. Additionally, the mixture can be cooled to any convenient temperature, depending on the use of the mixture.

Step 116 is the step of forming the mixture from step 114 into a hard candy. This step can be performed in any convenient and/or known manner, such as the addition of sweetener and/or corn syrup followed by dehydrating the mixture until it reaches an appropriate consistency to form a hard candy. In alternate embodiments, any other convenient or known manner of manufacturing hard candies may be used.

Step 118 is the step of mixing the mixture from step 114 with alternate beverages. In one embodiment, the mixture from step 114 can be mixed with an alcoholic beverage, such as vodka, whisky, brandy, malt liquor and/or any mixture of or individual known and/or convenient alcoholic beverage. In alternate embodiments, the mixture from step 114 may be added to any known and/or convenient soft drink, such as a lemon, lemon-lime, orange, cola, root beer and/or any other soft drink.

Step 120 is the step of dehydrating the mixture from step 114 to form a concentrated or powdered product. In one embodiment, the dehydrated product can be combined with vitamins and minerals to make either a liquid and/or pill form vitamin. In an alternate embodiment, the powdered product can be added to any food product to create a palatable product, such as graham crackers.

Step 122 is the step of freezing the mixture from step 114 to form a frozen form of the mixture. In one embodiment, the mixture from step 114 can be further sweetened and/or dehydrated in any convenient manner and/or combined with additional materials to form a palatable frozen form of the mixture, such as sherbert and/or gelato.

Step 124 is the step of mixing and/or combining the mixture of step 114 with various other foods. In one embodiment, the mixture can condensed, dehydrated and/or sweetened in any convenient manner and used as a filling and/or additional ingredient in chocolate. In alternate embodiment, the mixture can be combined with any other sweet and/or savory food, such as chocolate and/or pastries. In a still further alternate embodiment, the mixture can be combined with a thickening agent and formed into a gelatine.

Steps 102-110 describe one embodiment of the steps involved in the manufacture of the infused mixture, prior to the addition of the juice. In an alternate embodiment, the steps 102-110 may be performed in any convenient sequence.

In alternate embodiments, the aeration of fruit juices has been suggested for the purpose of improving its taste. For example, manufacturers or packers of concentrated juices have suggested that the concentrate be poured back and forth from one vessel to another after the specified quantity of water is added so as to aerate the beverage and give it a fresh, natural taste. Although it is not intended to limit the present invention to any particular theory, the fresh, natural appearance and good taste of the beverage of the present invention may be due to the fact that the glycyrrhia or some other constituent of the licorice acts as a sort of a forming agent so as to entrap air bubbles in the fruit juice thereby providing a frothy appearance and pleasant taste.

The method of the present invention will be further illustrated by the following non-limiting examples.

### EXAMPLE 1

Two and one-half ounces (avoir.) of a pelleted licorice root are added to three-fourths of a cup of water (6 fluid ounces) and the admixture is heated to its boiling point. At the first sign of ebullition or boiling, two level teaspoons of granulated sugar (sucrose) are added to the vessel containing the boiling admixture of licorice and water. A suitable closure means, i.e., a lid is placed on the vessel and the contents of the vessel are maintained under boiling conditions for a period of two minutes.

Next, two to three drops of vanilla extract, or other extracts are added to the heated mixture.

Next, the vessel is removed from the heat and the contents are allowed to steep for a period of two minutes. The contents of the vessel are then filtered through a fine screen, and admixed with one and one-half (1½) cups, i.e. 12 fluid ounces, of orange juice and one-half (½) cup, i.e. four fluid ounces, of lemon juice. This admixture of the citrus juices with the licorice-containing admixture is conducted at ordinary room temperature, i.e. 75 to 78 degrees Fahrenheit.

### EXAMPLE 2

Three-fourths of a cup of water (6 fluid ounces) are heated to near its boiling point. Two and one-half ounces (avoir.) of a pelleted licorice root are added to three-fourths of a cup of water (6 fluid ounces) and two level teaspoons of any sweetener are added and the admixture is heated to its boiling point. A suitable closure means, i.e., a lid is placed on the vessel and the contents of the vessel are maintained under boiling conditions for a period of one and one-half minutes.

During the boiling period, two to three drops of peppermint oil, and/or other oils and/or extracts are added to the boiling mixture. The mixture is boiled until the end of the one and one-half minute boiling period.

Next, the vessel is removed from the heat and the contents are allowed to steep for a period of two minutes. The contents of the vessel are then filtered through a fine screen, and admixed with one and one-half (1½) cups, i.e. 12 fluid ounces, of grape juice and one-half (½) cup, i.e. four fluid ounces, of cranberry juice. This admixture of the juices with the licorice-containing admixture is conducted at ordinary room temperature, i.e. 75 to 78 degrees Fahrenheit.

It should be understood that the particular embodiments described above are only illustrative of the principles of the present invention, and various modifications could be made by those skilled in the art without departing from the scope and spirit of the invention. Thus, the scope of the present invention is limited only by the claim that follows.

1. A method of manufacturing a beverage comprising the steps of:
heating a mixture of water, licorice flavored material and sweetener, and combining flavoring with said mixture to form a first combination.

2. The method of claim 1, further comprising the step of adding juice to said combination to form a second combination.

3. The method of claim 2, wherein the juice is selected from the group consisting of lemon, orange, lime, mandarin, tangerine, pear, grapefruit, cherry, pineapple, strawberry, cranberry, mango, pomegranate, apple, blackberry, blueberry, lingonberry and loganberry.

4. The method of claim 1, wherein the sweetener is selected from the group consisting of sugar, honey, sugar cane, sucrose, sucralose, aspartame, saccharine, fructose and stevia.

5. The method of claim 2, further comprising the step of cooling the second combination to form a hard candy.

5. The method of claim 2, further comprising the steps of mixing the second combination with a beverage.

6. The method of claim 5, wherein the beverage is selected from the group consisting of vodka, whisky, brandy, malt liquor, beer, lemon-lime soda, orange soda, cola, and root beer.

7. The method of claim 2, further comprising the steps of cooling the second combination, and
dehydrating the second combination to form a concentrate or powdered product.

8. The method of claim 2, further comprising the steps of freezing the second combination to form a frozen product.

9. The method of claim 8, wherein said frozen product is combined with additional materials to form a palatable frozen dessert.

10. The method of claim 2, further comprising the steps of combining said second combination with another food substance or beverage.

11. The method of claim 2, further comprising the step of combining the second combination with a thickening agent to form a gelatine.

12. The method of claim 2, further comprising the step of aerating the second combination.

13. The method of claim 1, wherein the flavoring is selected from the group consisting of vanilla extract, peppermint and spearmint.

14. A licorice-containing beverage, comprising water, licorice flavored material, sweetener, and flavoring.
